(19) United States
(12) Patent Application Publication
(10) Pub. No.: US 2026/0229439 A1
(43) Pub. Date: Aug. 6, 2026

(54) FUSE UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/529,135

(22) Filed: Feb. 4, 2026

(30) Foreign Application Priority Data
Feb. 5, 2025 (JP) 2025-017324

(51) Int. Cl. H01H 85/175; H01H 85/143; H01M 50/502; H01M 50/569; H01M 50/583

(52) U.S. Cl. CPC H01H 85/175; H01H 85/143; H01M 50/502; H01M 50/569; H01M 50/583

(57) ABSTRACT

A fuse unit includes a fuse having a first electrode, a second electrode, and a fusible portion between the first electrode and the second electrode, a first conductive member connected to the first electrode, a second conductive member connected to the second electrode, and a holding member made of a resin which holds the first conductive member and the second conductive member, wherein the holding member has a main body that holds the first conductive member and the second conductive member, and a leg portion that protrudes from the main body and supports the main body.

### CROSS-REFERENCE TO RELATED APPLICATIONS

The present application claims priority to and incorporates by reference the entire contents of Japanese Patent Application No. 2025-017324 filed in Japan on February 5, 2025.

### BACKGROUND OF THE INVENTION

### 1. Field of the Invention

The present invention relates to a fuse unit and a conductive module.

### 2. Description of the Related Art

In the related art, there is a fuse unit. JP 7 561 318 B2 discloses a fuse unit including a first terminal electrically connected to a mating member, a second terminal electrically connected directly or indirectly to a wiring member, a resin portion covering a part of the first terminal and a part of the second terminal, and a chip fuse.

Here, from the viewpoint of stabilizing the performance of the fuse, it is desirable that the influence of heat from the outside on the fuse can be reduced.

### SUMMARY OF THE INVENTION

An object of the present invention is to provide a fuse unit and a conductive module capable of reducing the influence of heat from the outside on a fuse.

In order to achieve the above mentioned object, a fuse unit according to one aspect of the present invention includes a fuse having a first electrode, a second electrode, and a fusible portion between the first electrode and the second electrode; a first conductive member connected to the first electrode; a second conductive member connected to the second electrode; and a holding member made of a resin which holds the first conductive member and the second conductive member and accommodates the fuse, wherein the holding member has a main body that holds the first conductive member and the second conductive member, and a leg portion that protrudes from the main body and supports the main body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a conductive module according to an embodiment;

FIG. 2 is a plan view of the conductive module according to the embodiment;

FIG. 3 is a perspective view of a fuse unit according to the embodiment;

FIG. 4 is a plan view of a first conductive member, a second conductive member, and a fuse according to the embodiment;

FIG. 5 is a plan view of the fuse unit according to the embodiment;

FIG. 6 is a perspective view of the fuse unit according to the embodiment; and

FIG. 7 is a side view of the conductive module according to the embodiment.

### DETAILED DESCRIPTION OF THE PREFERRED EMBODIMENTS

Hereinafter, a fuse unit and a conductive module according to an embodiment of the present invention will be described in detail with reference to the drawings. The present invention is not limited by the embodiment. In addition, constituent elements in the following embodiment include those that can be easily assumed by those skilled in the art or those that are substantially the same as actual ones.

### Embodiment

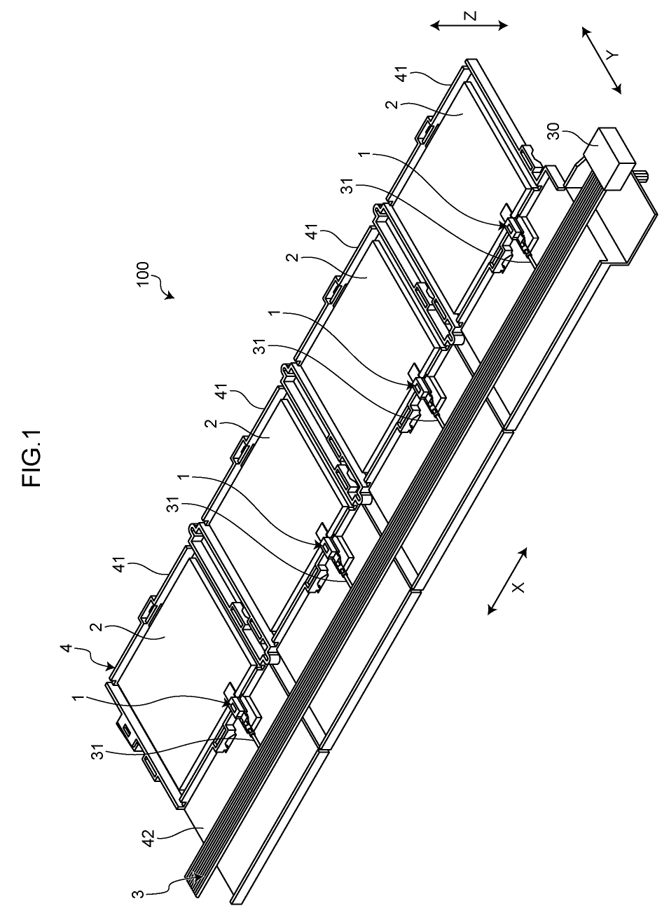

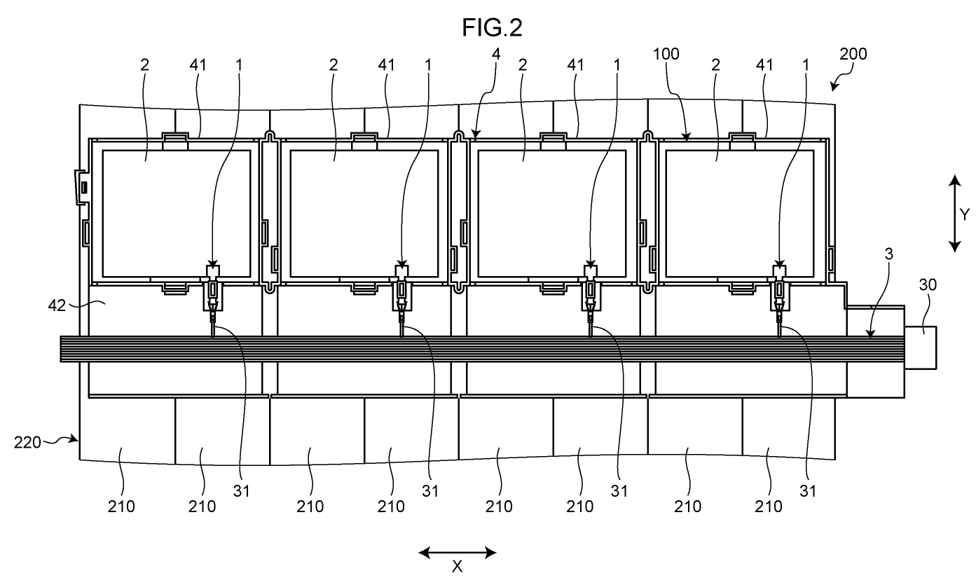

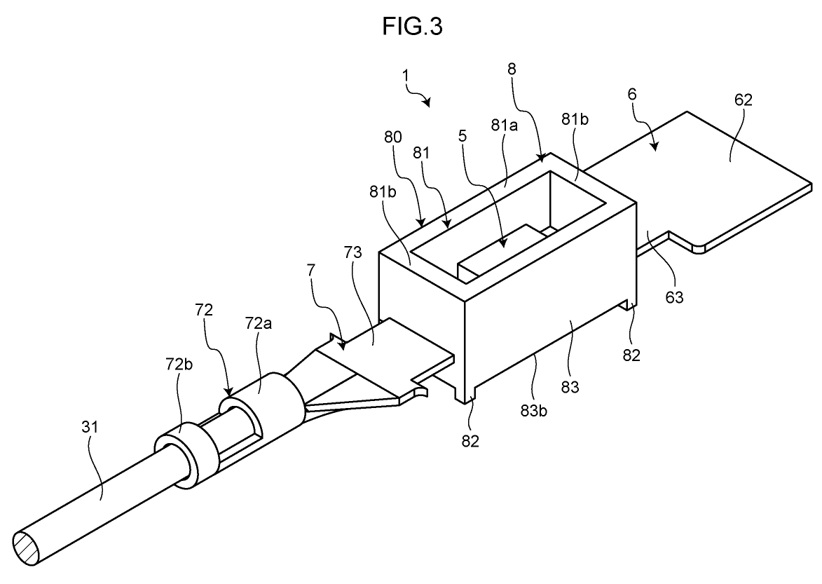

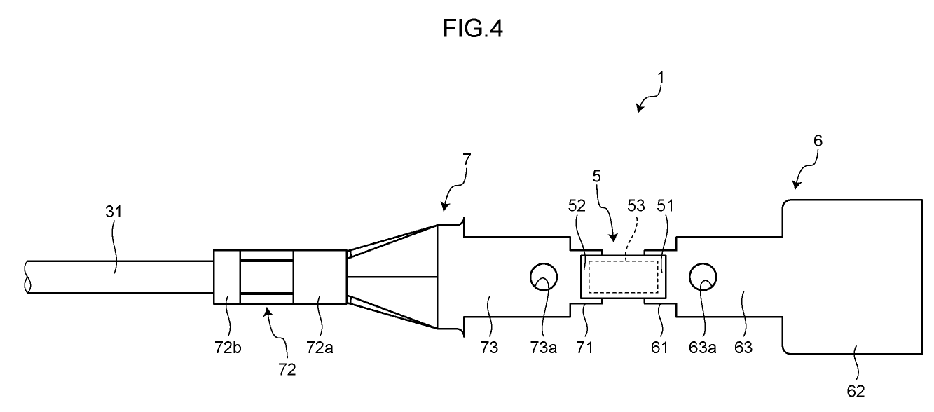

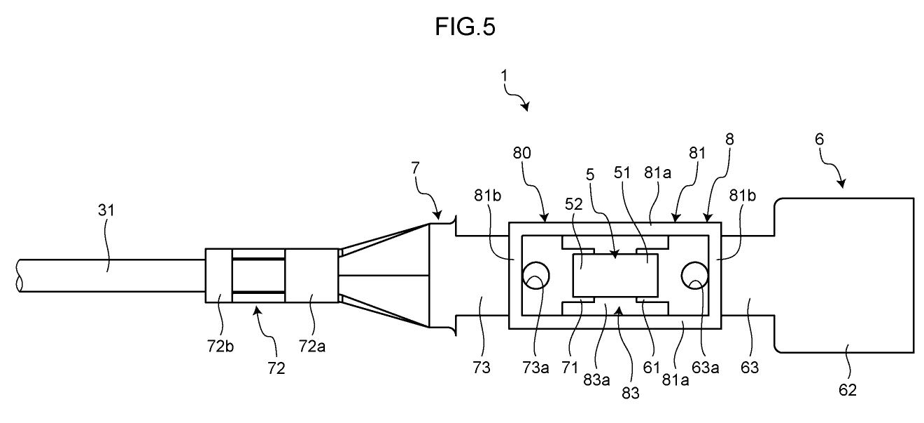

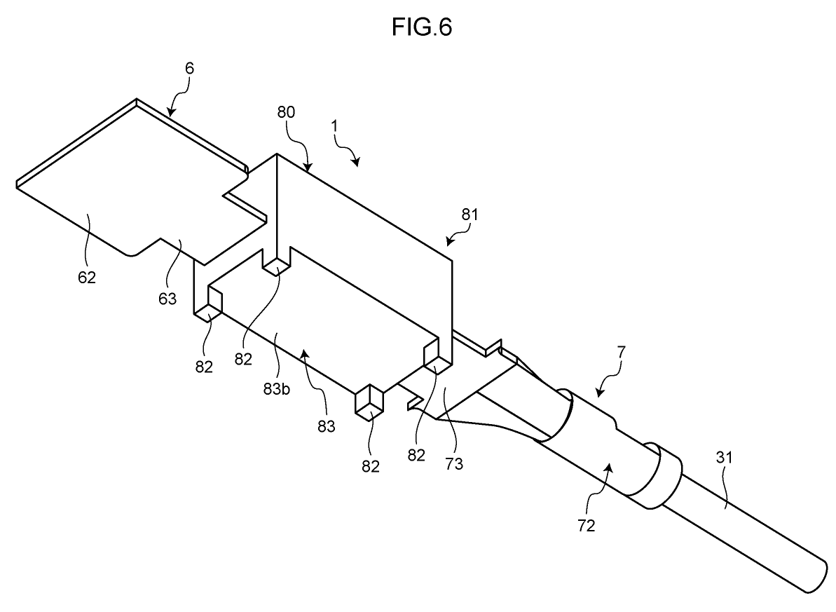

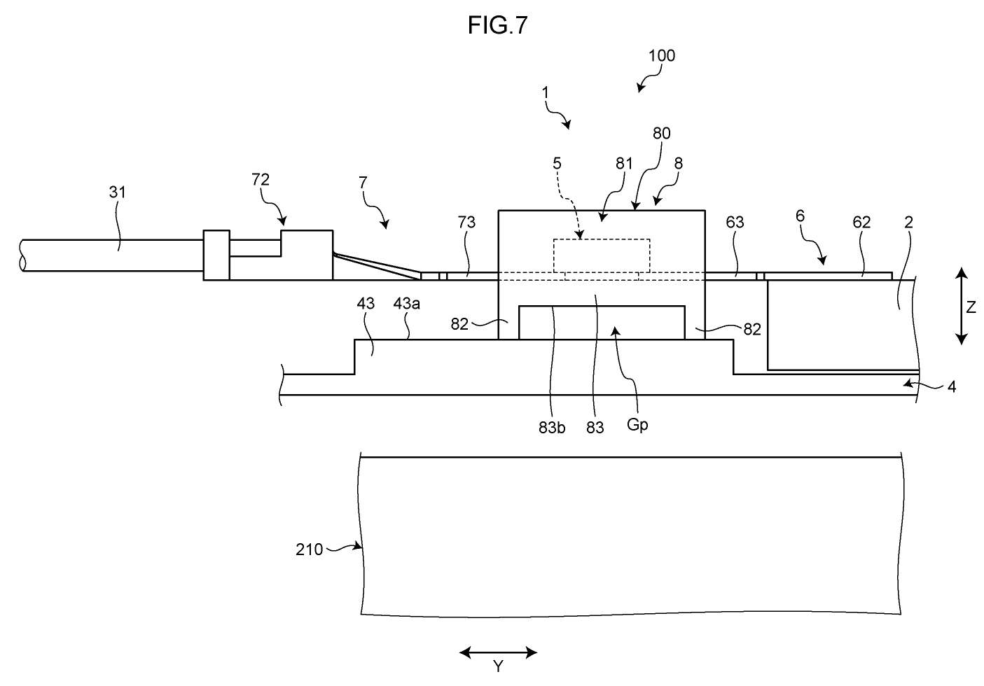

An embodiment will be described with reference to FIGS. 1 to 7. The present embodiment relates to a fuse unit and a conductive module. FIG. 1 is a perspective view of a conductive module according to an embodiment, FIG. 2 is a plan view of the conductive module according to the embodiment, FIG. 3 is a perspective view of a fuse unit according to the embodiment, FIG. 4 is a plan view of a first conductive member, a second conductive member, and a fuse according to the embodiment, FIG. 5 is a plan view of the fuse unit according to the embodiment, FIG. 6 is a perspective view of the fuse unit according to the embodiment, and FIG. 7 is a side view of the conductive module according to the embodiment.

As illustrated in FIG. 1, a conductive module 100 of the present embodiment is a bus bar module having a fuse unit 1, a bus bar 2, a routing member 3, a case 4, and a connector 30. The conductive module 100 is disposed in a battery pack 200, for example, as illustrated in FIG. 2. The battery pack 200 is mounted as a power source on a vehicle such as an automobile. The battery pack 200 has a plurality of battery cells 210. The battery cells 210 are arranged in a first direction X. The plurality of battery cells 210 form a battery module 220. The conductive module 100 of FIG. 2 is assembled to the battery module 220.

The bus bar 2 is formed of a conductive metal plate. The bus bar 2 electrically connects two adjacent battery cells 210. More specifically, the bus bar 2 is fixed to an electrode of one battery cell 210 and an electrode of the other battery cell 210, and electrically connects the two electrodes. The conductive module 100 of the present embodiment has a plurality of bus bars 2 arranged in the first direction X and a plurality of fuse units 1 corresponding to the plurality of bus bars 2.

The routing member 3 has a plurality of detection lines 31 and is routed in the first direction X. The illustrated routing member 3 is a flat routing member. The illustrated routing member 3 is a flexible flat cable including a plurality of electric wires and a sheath covering the plurality of electric wires. Each electric wire is connected to the corresponding bus bar 2 and functions as the detection line 31. A connector 30 is disposed at an end portion of the routing member 3. Each detection line 31 is connected to a terminal of the connector 30. The detection line 31 is connected to, for example, a monitoring device that monitors the battery pack 200. In this case, the monitoring device acquires a voltage of the battery cell 210 via the detection line 31, and monitors a state of the battery module 220.

The case 4 is a member that supports and accommodates the fuse unit 1, the bus bar 2, and the routing member 3, and is assembled to the battery pack 200. The case 4 is formed of, for example, an insulating synthetic resin. The case 4 has a holding portion 41 that holds the bus bar 2 and a routing path 42 that supports the routing member 3. The case 4 of the present embodiment has a plurality of holding portions 41 arranged in the first direction X. The routing path 42 is adjacent to the plurality of holding portions 41 and extends in the first direction X. The routing member 3 is placed on the routing path 42 so as to extend in the first direction X.

The fuse unit 1 is disposed between the detection line 31 and the bus bar 2. As illustrated in FIG. 3, the fuse unit 1 has a fuse 5, a first conductive member 6, a second conductive member 7, a holding member 8 made of a resin. The fuse 5 is a circuit protection component that cuts off a circuit when an overcurrent flows. The fuse 5 of the present embodiment is a chip fuse.

FIG. 4 illustrates the fuse 5, the first conductive member 6, and the second conductive member 7 which are portions of the fuse unit 1 excluding the holding member 8. As illustrated in FIG. 4, the fuse 5 has a first electrode 51, a second electrode 52, and a fusible portion 53.

The first electrode 51 is connected to one end portion of the fusible portion 53. The second electrode 52 is connected to the other end portion of the fusible portion 53. The fusible portion 53 is configured to cut off a portion between the first electrode 51 and the second electrode 52 by fusing when an overcurrent flows. The fusible portion 53 is, for example, a fuse element having predetermined fusing characteristics.

The first conductive member 6 and the second conductive member 7 are members having conductivity, and are formed of, for example, metal plates. The first conductive member 6 is connected to the first electrode 51 of the fuse 5. The second conductive member 7 is connected to the second electrode 52 of the fuse 5. That is, the fuse 5 is a protective component interposed between the first conductive member 6 and the second conductive member 7.

The first conductive member 6 has a first connecting portion 61, a second connecting portion 62, and an intermediate portion 63. The illustrated first conductive member 6 is a flat plate-like member having a linear shape in a plan view. The first connecting portion 61 is an end portion on one side of the first conductive member 6, and the second connecting portion 62 is an end portion on the other side. The first connecting portion 61 is formed so as to be joinable to the first electrode 51 of the fuse 5. The first connecting portion 61 has a rectangular flat plate shape and has a width slightly greater than that of the first electrode 51. The first connecting portion 61 is joined to the first electrode 51 by means of, for example, solder or the like.

The second connecting portion 62 is formed so as to be joinable to the bus bar 2. The second connecting portion 62 has a rectangular flat plate shape and has a width greater than that of the first connecting portion 61. The second connecting portion 62 is joined to the bus bar 2 by means of, for example, solder, welding, or the like. The intermediate portion 63 is a portion between the first connecting portion 61 and the second connecting portion 62. The shape of the intermediate portion 63 in a plan view is rectangular. The width of the intermediate portion 63 is greater than the width of the first connecting portion 61 and smaller than the width of the second connecting portion 62. The intermediate portion 63 is provided with a through hole 63a. The illustrated shape of the through hole 63a is circular.

The second conductive member 7 has a first connecting portion 71, a second connecting portion 72, and an intermediate portion 73. The illustrated second conductive member 7 is a crimp terminal having a linear shape in a plan view. The first connecting portion 71 is an end portion on one side of the second conductive member 7, and the second connecting portion 72 is an end portion on the other side. The first connecting portion 71 is formed so as to be joinable to the second electrode 52 of the fuse 5. The first connecting portion 71 has a rectangular flat plate shape and has a width slightly greater than that of the second electrode 52.

The illustrated second connecting portion 72 is a crimp portion crimped to the detection line 31. The second connecting portion 72 has a core wire crimp portion 72a and a sheath crimp portion 72b. The core wire crimp portion 72a is crimped to a core wire of the detection line 31 and holds the core wire. The sheath crimp portion 72b is crimped to an insulation sheath of the detection line 31 and hold the sheath. The shapes of the crimp portions 72a and 72b after being crimped are, for example, cylindrical shapes.

The intermediate portion 73 is a portion between the first connecting portion 71 and the second connecting portion 72. The shape of the intermediate portion 73 in a plan view is rectangular. The width of the intermediate portion 73 is greater than the width of the first connecting portion 71. The intermediate portion 73 is provided with a through hole 73a. The illustrated shape of the through hole 73a is circular.

In the illustrated fuse unit 1, the first conductive member 6, the fuse 5, and the second conductive member 7 are linearly disposed. That is, the first conductive member 6 extends from the first electrode 51 to one side in a longitudinal direction of the fuse 5, and the second conductive member 7 extends from the second electrode 52 to the other side in the longitudinal direction.

As illustrated in FIGS. 3 and 5, the holding member 8 is integrally formed with the first conductive member 6 and the second conductive member 7, and holds the first conductive member 6 and the second conductive member 7. The holding member 8 is insert-molded using, for example, an insulating synthetic resin. In this case, the holding member 8 is molded with respect to the first conductive member 6 and the second conductive member 7 held at predetermined relative positions by a mold. The holding member 8 is formed so as to expose the two connecting portions 61 and 62 of the first conductive member 6 and the two connecting portions 71 and 72 of the second conductive member 7. The fuse 5 may be connected to the conductive members 6 and 7 after the holding member 8 is formed, or may be connected to the conductive members 6 and 7 before the holding member 8 is formed.

The holding member 8 has a main body 80 and leg portions 82 that support the main body 80. The main body 80 is a portion that holds the first conductive member 6 and the second conductive member 7. The illustrated main body 80 has a bottomed tubular shape and can accommodate the fuse 5 therein.

The main body 80 of the present embodiment has a bottom wall 83 and a frame-shaped side wall 81. The illustrated shape of the bottom wall 83 is a rectangular plate shape. As illustrated in FIGS. 5 and 6, the bottom wall 83 has a first surface 83a and a second surface 83b. The first surface 83a is a surface facing an accommodation space of the main body 80. The fuse 5 is disposed on the first surface 83a side with respect to the bottom wall 83, and is accommodated in the accommodation space. The side wall 81 is erected from the first surface 83a and surrounds the fuse 5. The second surface 83b is a surface facing a side opposite to the first surface 83a, and faces an external space of the main body 80. The leg portions 82 protrude from the second surface 83b. A protruding direction of the leg portions 82 is a direction orthogonal to the second surface 83b.

The illustrated shape of each of the leg portions 82 is a columnar shape, for example, a prismatic shape. As illustrated in FIG. 6, the holding member 8 of the present embodiment has a plurality of leg portions 82. The plurality of leg portions 82 are disposed to be separated from each other. The holding member 8 of the present embodiment has four leg portions 82 disposed at corner portions of the bottom wall 83.

The side wall 81 has a rectangular frame shape. More specifically, the side wall 81 has a pair of flat plate-shaped first wall portions 81a and a pair of flat plate-shaped second wall portions 81b. The pair of first wall portions 81a face each other in a width direction of the conductive members 6 and 7. The pair of second wall portions 81b face each other in a longitudinal direction of the conductive members 6 and 7. The second wall portion 81b extends from one first wall portion 81a to the other first wall portion 81a.

The main body 80 is formed such that the two conductive members 6 and 7 pass through the side wall 81. For example, the intermediate portion 63 of the first conductive member 6 passes through one second wall portion 81b. The first connecting portion 61 is exposed to an internal space of the main body 80, and the second connecting portion 62 protrudes to the outside of the main body 80. The through hole 63a of the intermediate portion 63 is located in a region surrounded by the side wall 81. The resin forming the bottom wall 83 fills the through hole 63a and locks the intermediate portion 63.

The intermediate portion 73 of the second conductive member 7 passes through the other second wall portions 81b. The first connecting portion 71 is exposed to the internal space of the main body 80, and the second connecting portion 72 protrudes to the outside of the main body 80. The through hole 73a of the intermediate portion 73 is located in the region surrounded by the side wall 81. The resin forming the bottom wall 83 fills the through hole 73a and locks the intermediate portion 73.

As illustrated in FIG. 7, the leg portions 82 of the fuse unit 1 are supported by a support surface 43a. The support surface 43a is, for example, a surface of the case 4 of the conductive module 100. The support surface 43a is, for example, a surface that supports the holding member 8 from below. The support surface 43a is typically a flat surface. The holding member 8 is configured such that the plurality of leg portions 82 can be brought into contact with one support surface 43a. In this case, distal end surfaces of the plurality of leg portions 82 are preferably disposed on the same plane.

As illustrated in FIG. 7, the leg portions 82 are configured to form a gap Gp between the support surface 43a and the second surface 83b of the bottom wall 83. In other words, the leg portions 82 are formed such that the second surface 83b of the bottom wall 83 can be separated from the support surface 43a. The holding member 8 having the leg portions 82 can reduce the influence of heat on the fuse 5. For example, the gap Gp formed by the leg portions 82 can make it difficult to transfer the heat of the battery cell 210 or the heat of the bus bar 2 to the fuse 5. Since the bottom wall 83 is supported by the leg portions 82, heat is less likely to be transferred from the support surface 43a to the bottom wall 83 as compared with a case where the entire second surface 83b of the holding member 8 is in contact with the support surface 43a.

Further, the gap Gp can promote heat radiation of the bottom wall 83 and suppress a temperature rise of the fuse 5. Since the plurality of leg portions 82 are separated from each other, heat is easily released from the gap Gp to the outside.

The support surface 43a may be provided on a raised portion 43 where a part of the case 4 is raised. That is, the plurality of leg portions 82 may be placed on the raised portion 43 of the case 4. In this case, the distance from the battery cell 210 to the fuse 5 can be increased. In addition, since the raised portion 43 having the support surface 43a is thick, the temperature rise of the support surface 43a is easily suppressed.

The leg portions 82 may not be fixed to the support surface 43a. For example, the leg portions 82 may be supported by the support surface 43a so as to be relatively movable with respect to the support surface 43a. In this case, a load on each portion when the first conductive member 6 is joined to the bus bar 2 is suppressed. When the first conductive member 6 is joined to the bus bar 2, vibration or heat is applied to the first conductive member 6. At this time, since the holding member 8 is movable, excessive stress is less likely to act on the fuse 5 or a joint portion between the fuse 5 and the conductive members 6 and 7.

The main body 80 of the holding member 8 may be filled with a potting agent for protecting the fuse 5. The potting agent fills the accommodation space formed by the bottom wall 83 and the side wall 81 and covers the fuse 5 and the two first connecting portions 61 and 71.

As described above, the fuse unit 1 of the present embodiment has the fuse 5, the first conductive member 6, the second conductive member 7, and the holding member 8. The fuse 5 has the first electrode 51, the second electrode 52, and the fusible portion 53 between the first electrode 51 and the second electrode 52. The first conductive member 6 is connected to the first electrode 51. The second conductive member 7 is connected to the second electrode 52. The holding member 8 is made of a resin, holds the first conductive member 6 and the second conductive member 7, and accommodates the fuse 5.

The holding member 8 has the main body 80 and the leg portions 82. The main body 80 holds the first conductive member 6 and the second conductive member 7. The leg portions 82 protrude from the main body 80 and support the main body 80. The fuse unit 1 according to the present embodiment includes the leg portions 82 that support the main body 80, and thus it is possible to reduce the influence of heat from the outside on the fuse 5.

The main body 80 of the present embodiment includes the bottom wall 83 having the first surface 83a and the second surface 83b facing sides opposite to each other. The fuse 5 is disposed on the first surface 83a side with respect to the bottom wall 83. The leg portions 82 protrude from the second surface 83b, and are configured to form the gap Gp between the support surface 43a and the second surface 83b. The support surface 43a is a surface that supports the distal ends of the leg portions 82. Since the gap Gp is formed between the support surface 43a and the second surface 83b, the influence of heat from the outside on the fuse 5 is reduced.

The holding member 8 of the present embodiment has the frame-shaped side wall 81 erected from the first surface 83a of the bottom wall 83. The side wall 81 surrounds the fuse 5 and can protect the fuse 5 from heat.

The first conductive member 6 and the second conductive member 7 of the present embodiment pass through the side wall 81 and are connected to the fuse 5 in a space portion surrounded by the side wall 81. The holding member 8 having the leg portions 82 can separate the two conductive members 6 and 7 from the support surface 43a and suppress heat transfer to the fuse 5 via the conductive members 6 and 7.

The holding member 8 of the present embodiment has the plurality of leg portions 82 disposed to be separated from each other, and is configured to be able to bring the plurality of leg portions 82 into contact with the support surface 43a. With such a configuration, circulation of air between the gap Gp and the external space is promoted.

The conductive module 100 of the present embodiment has the fuse unit 1, the bus bar 2 connected to the first conductive member 6, the detection line 31, and the case 4. The detection line 31 is a voltage detection line connected to the second conductive member 7. The case 4 is a support member that supports the bus bar 2 and the fuse unit 1. The leg portions 82 are supported by the case 4 so as to form the gap Gp between the case 4 and the main body 80. The conductive module 100 of the present embodiment can reduce the influence of heat from the outside on the fuse 5.

The shape and number of the leg portions 82 of the holding member 8 are not limited to the illustrated shape and number. For example, the shape of each of the leg portions 82 may be a cylindrical shape or other shapes. The distal end of the leg portions 82 may be a flat surface or a curved surface. When the distal end of the leg portion 82 is a curved surface, the contact area between the support surface 43a and the leg portion 82 can be reduced.

The leg portion 82 illustrated in FIG. 6 is disposed at each corner portion of the bottom wall 83. Alternatively, the leg portion 82 may be an elongated rib extending from one corner portion to the other corner portion of the bottom wall 83. In this case, the leg portion 82 may extend in the width direction of the conductive members 6 and 7, or may extend in the longitudinal direction of the conductive members 6 and 7. The main body 80 of the holding member 8 may be supported by two elongated ribs. For example, the main body 80 may be supported by two ribs disposed at both ends of the bottom wall 83 in a longitudinal direction, or may be supported by two ribs disposed at both ends of the bottom wall 83 in a width direction.

The application target of the fuse unit 1 is not limited to the battery module 220. The fuse unit 1 may be applied as a protection circuit to other devices. The target to which the first conductive member 6 is connected is not limited to the bus bar 2. The second connecting portion 62 of the first conductive member 6 may be connected to a routing member such as an electric wire, or may be connected to another conductive member. The target to which the second conductive member 7 is connected is not limited to the electric wire. The second connecting portion 72 of the second conductive member 7 may be connected to a circuit of a flexible printed circuit board or the like, or may be connected to another conductive member.

The contents disclosed in the above embodiments can be appropriately combined and executed.

In the fuse unit according to the present embodiment, the holding member includes the main body that holds the first conductive member and the second conductive member, and the leg portion that protrudes from the main body and supports the main body. The fuse unit according to the present embodiment has an advantage of being capable of reducing the influence of heat from the outside on the fuse.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a fuse having a first electrode, a second electrode, and a fusible portion between the first electrode and the second electrode;
a first conductive member connected to the first electrode;
a second conductive member connected to the second electrode; and
a holding member made of a resin which holds the first conductive member and the second conductive member and accommodates the fuse,
wherein the holding member has a main body that holds the first conductive member and the second conductive member, and a leg portion that protrudes from the main body and supports the main body.

2. The fuse unit according to claim 1,
wherein the main body includes a bottom wall having a first surface and a second surface facing sides opposite to each other,
wherein the fuse is disposed on a side of the first surface with respect to the bottom wall, and
wherein the leg portion protrudes from the second surface, and is configured to form a gap between a support surface that supports a distal end of the leg portion and the second surface.

3. The fuse unit according to claim 2, wherein the holding member has a frame-shaped side wall that is erected from the first surface of the bottom wall and surrounds the fuse.

4. The fuse unit according to claim 3, wherein the first conductive member and the second conductive member pass through the side wall and are connected to the fuse in a space portion surrounded by the side wall.

5. The fuse unit according to claim 2, wherein the holding member has a plurality of the leg portions disposed to be separated from each other, and is configured to be able to bring the plurality of leg portions into contact with the support surface.

6. A conductive module comprising:
the fuse unit according to claim 1;
a bus bar connected to the first conductive member;
a voltage detection line connected to the second conductive member; and
a support member that supports the bus bar and the fuse unit,
wherein the leg portion is supported by the support member so as to form a gap between the support member and the main body.
